(19) United States
(12) Patent Application Publication
(10) Pub. No.: US 2024/0320641 A1
(43) Pub. Date: Sep. 26, 2024

(54) SYSTEMS AND METHODS FOR BARCODE-BASED DIGITAL ASSET ALLOCATION

(71) Applicant: Wells Fargo Bank, N.A., San Francisco, CA (US)

(72) Inventor: Molly Gassel, Tega Cay, SC (US)

(21) Appl. No.: 18/187,496

(22) Filed: Mar. 21, 2023

(51) Int. Cl. G06Q 20/10; G06K 7/14; G06Q 20/32; G06Q 20/40; G06Q 50/26

(52) U.S. Cl. CPC G06Q 20/108; G06K 7/1413; G06Q 20/3276; G06Q 20/4016; G06Q 50/265

(57) ABSTRACT

Systems, apparatuses, methods, and computer program products are disclosed for barcode-based digital asset allocation. An example method includes generating, by data generation circuitry, allocation data comprising a user identifier, two or more account identifiers, and one or more amount identifiers. The example method also includes causing transmission, by communications hardware, of the allocation data. The example method also includes receiving, by the communications hardware, a barcode based on the allocation data. The example method also includes utilizing, by the communications hardware, the barcode to cause a distribution of assets in one or more amounts corresponding to the one or more amount identifiers in connection with two or more accounts corresponding to the two or more account identifiers.

### BACKGROUND

Budgeting software typically requires a user to link a personal financial account to the budgeting software by providing online banking credentials to a third party associated with the software. However, by doing so, the user is exposed to numerous risks, such as potential security breaches and fraudulent transactions. Personal data may also be shared with the third party, resulting in unwanted solicitations.

### BRIEF SUMMARY

Existing services related to financial operations including deposits, withdrawals, and budgeting exhibit numerous technical issues. As noted above, budgeting software is often managed by a third-party entity distinct from a user's bank or other financial institution. Such third-party budgeting software often requires linkage to bank accounts in order to import and categorize financial transactions. Once linked, the third-party budgeting software may access transaction history and various account information which can be used to create budgets, track spending, and/or provide insights. Some budgeting software solutions utilize the concept of “buckets,” or virtual sub accounts within a single account. These virtual sub accounts can be created and defined by users to represent specific categories or types of expenses or goals, such as, for example, groceries, rent, utility bills, entertainment, vacation funds, etc. In this manner, users can allocate certain amounts from their total account balance into the virtual sub accounts to gain a clearer picture of their financial standing and outlook.

While the tradeoff of sensitive information to a third-party entity for access to these budgeting tools may be convenient, there is a risk that the sensitive information shared may become compromised (e.g., via a security breach of the third-party entity, interception during transmission, etc.), potentially leading to identity theft or other fraud.

In some instances, budgeting software may be first-party software, i.e., integrated into a bank's platform and managed by the bank internally without the need for a third-party entity. However, first-party budgeting software also exhibits numerous issues similar to third-party budgeting software. For example, existing budgeting software solutions (whether first-party or third-party) lack real-time management capabilities. For instance, to allocate funds from a deposited check into virtual sub accounts, a user is required to log in to their electronic banking platform (e.g., via a browser or mobile application) and manage the allocations via one or more user interfaces, only after the deposit has taken place. In some instances, the user may have to wait until the check clears and the funds appear in their bank account in order to allocate the funds into virtual sub accounts. In this regard, there is no way for a user to, in real-time and at the point of or during a transaction (e.g., a deposit, withdrawal, purchase, etc.), specify how they would prefer the transaction be represented in the context of their budgeting software (e.g., their virtual sub accounts).

In other circumstances, transactions such as deposits and withdrawals may encompass a negative user experience, especially in cases where an individual is required to frequently conduct deposits and/or withdrawals. As one example, an individual may be required to conduct frequent deposits and/or withdrawals due to the nature of their business. For instance, the individual may be a courier, landlord, business owner, investor, car dealer, pawn shop operator, or other profession that involves frequently performing deposits and/or withdrawals. In this regard, the individual may have multiple formal accounts (e.g., personal checking and/or savings account(s), business accounts, etc.) and each of these accounts may further be associated with virtual sub accounts as described above.

Each time the individual visits a branch to conduct a deposit or withdrawal, the individual may need to repeatedly specify (e.g., to a bank teller or via user interfaces displayed on a device such as an Automated Teller Machine (ATM)), a division of their transaction with respect to multiple accounts. For instance, when depositing a check, the individual may desire that 50% of the check be deposited into their business account, 30% of the check be deposited into their savings account, and 20% of the check be deposited into their personal checking account. Having to repeatedly express this formula each time the individual conducts a deposit leads to an inefficient and frustrating experience for the individual, especially when considering that the individual may have multiple allocation formulas in mind for differing financial instruments (e.g., a division of a personal check into multiple accounts may be different from a division of a business check, etc.). Similarly, a withdrawal may be just as complex and require an individual to expressly state various preferred ways to divide up withdrawals each time they visit a branch. Moreover, as discussed above, the individual still has no way to allocate the funds into virtual sub accounts other than doing so at a later time after the transaction has been performed.

In contrast to these conventional techniques for managing transactions and budgeting them accordingly, example embodiments described herein set forth systems, methods, computer program products, and apparatuses for barcode-based digital asset allocation. Example embodiments streamline financial transactions and offer increased speed and accuracy, enhanced security, and greater convenience and flexibility over conventional methods for allocating funds between multiple accounts. For instance, conventional manual entry of account information when distributing funds to multiple accounts comes with the risk of human errors (e.g., such as mistyping account information) which can lead to delays or incorrect payments. By utilizing barcodes, the process of this type of data entry is automated, thereby eliminating this risk and allowing a digital asset allocation to be performed quickly and with a high level of accuracy that ensures the funds are distributed to the correct accounts in a timely manner.

Example embodiments provide enhanced security by encoding account distribution information on a barcode and eliminating the need to expose account distribution information (e.g., by speaking to a bank teller). For instance, when distributing funds in conventional methods, there is always a risk of theft or fraud, particularly when using paper checks or cash. Barcodes, however, offer a more secure alternative, as they can be encrypted and authenticated, making it more difficult for unauthorized users to intercept or steal the funds (e.g., by manipulating the barcode or the like).

Further, example embodiments provide the ability for individuals to allocate funds, via a barcode, into multiple virtual sub accounts (e.g., “buckets”). By doing so, example embodiments are particularly helpful to historically unbanked individuals who may have recently joined a bank. In this regard, the individuals are enabled to migrate into a banking lifestyle while retaining the “envelope” budgeting concepts they may be more familiar with.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for barcode-based digital asset allocation.

FIG. 2A illustrates a schematic block diagram of example circuitry embodying a system device that may perform various operations in accordance with some example embodiments described herein.

FIG. 2B illustrates a schematic block diagram of example circuitry embodying a client device and/or a remote device that may perform various operations in accordance with some example embodiments described herein.

FIG. 3 illustrates an example flowchart for utilizing a barcode generated based on allocation data, in accordance with some example embodiments described herein.

FIG. 4 illustrates an example flowchart for generating a barcode based on allocation data, in accordance with some example embodiments described herein.

FIG. 5 illustrates an example flowchart for establishing a secure session with a client device, in accordance with some example embodiments described herein.

FIG. 6 illustrates an example flowchart for facilitating a display of a barcode in connection with a barcode display request, in accordance with some example embodiments described herein.

FIG. 7 illustrates an example flowchart for generating a recommendation based on received transaction data, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “barcode” refers to a visual, machine-readable code that represents data. A barcode may comprise a linear (e.g., one-dimensional (1D)) barcode or a matrix (e.g., two-dimensional (2D)) barcode, such as, for example, a Quick Response (QR) code. A one-dimensional barcode is made up of lines and spaces of various widths or sizes that create specific patterns. A two-dimensional barcode is similar to a one-dimensional barcode but can represent more data per unit area. A barcode may be scanned and read by specialized scanning apparatuses that use optical sensors to detect patterns in the barcode, e.g., barcode readers. Certain barcodes, such as QR codes may be scanned and read by mobile smartphones.

When a barcode is scanned (or read), the scanning device emits a beam of light that illuminates the barcode. The light is reflected off of the lines and spaces in the barcode, and the reflected light is detected by a photosensor in the scanning device. The photosensor may then convert the pattern into an electrical signal, which is then processed by a decoder of the scanning device. The decoder may interpret the electrical signal and identify data that the barcode represents. This information can be used to perform a variety of functions, depending on the application. For example, as discussed herein, scanning a barcode may cause a distribution of assets in connection with two or more accounts.

One of the key advantages of barcodes is their speed and accuracy. Due to the automation of the scanning process, barcodes can be read more efficiently and accurately than manually entering information into a computer system. This saves time and reduces potential human errors. Moreover, barcode readers can be relatively inexpensive and easy to use, making them accessible to a wide range of organizations.

### System Architecture

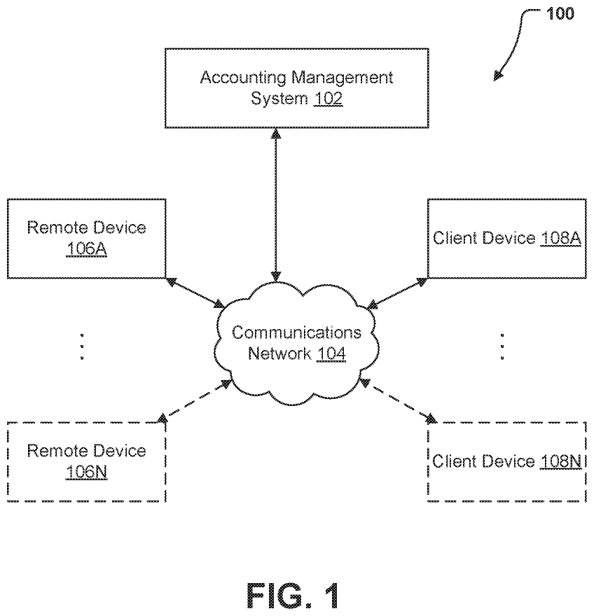

Example embodiments described herein may be implemented using any of a variety of computing devices or servers. To this end, FIG. 1 illustrates an example environment 100 within which various embodiments may operate. As illustrated, an accounting management system 102 may receive and/or transmit information via communications network 104 (e.g., the Internet) with any number of other devices, such as one or more of remote devices 106A-106N and/or client devices 108A-108N.

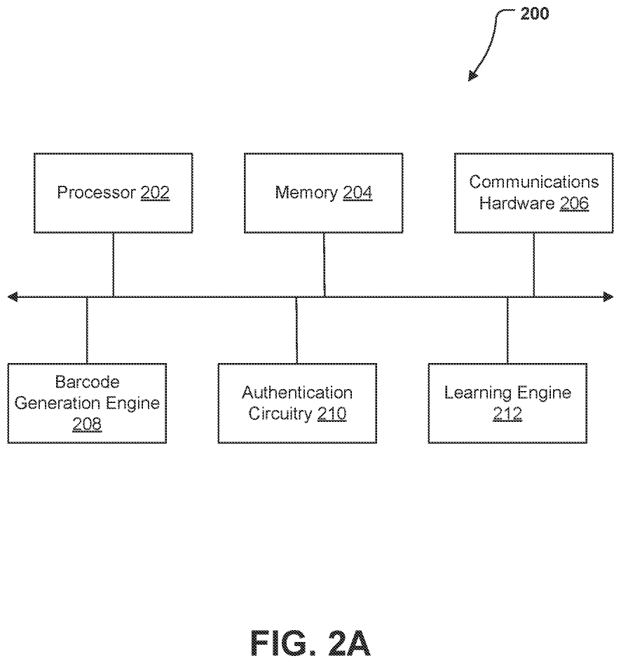

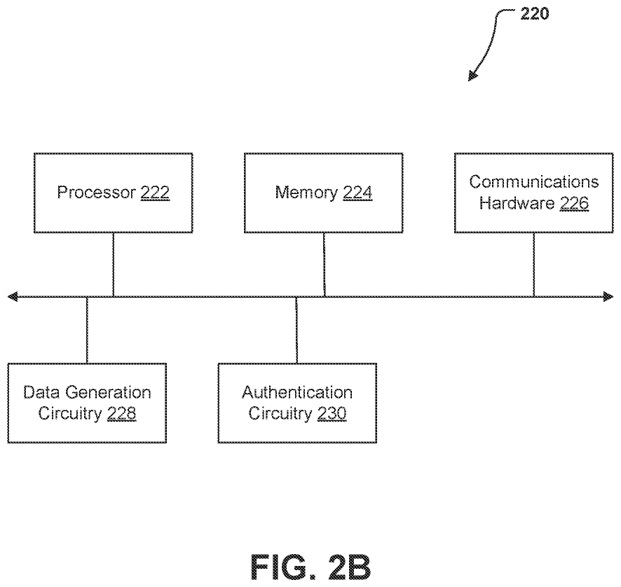

The accounting management system 102 may be implemented as one or more computing devices or servers, which may be composed of a series of components. Particular components of the accounting management system 102 are described in greater detail below with reference to apparatus 200 in connection with FIG. 2A.

The one or more remote devices 106A-106N and the one or more client devices 108A-108N may be embodied by any computing devices known in the art. The one or more remote devices 106A-106N and the one or more client devices 108A-108N need not themselves be independent devices, but may be peripheral devices communicatively coupled to other computing devices.

In various embodiments, remote devices 106A-106N may comprise devices belonging to or managed by an entity (e.g., a merchant, a financial institution such as a bank or credit union, and/or other businesses or organizations), and may include, for example, Automated Teller Machines (ATMs) or similar self-service kiosk devices, Point of Sale (POS) devices, and/or the like. In some example embodiments, these remote devices 106A-106N may communicate (e.g., via communications network 104) with the accounting management system 102, e.g., to process a barcode scanned in conjunction with a transaction (e.g., a deposit or withdrawal). In some embodiments, some remote devices 106A-106N may embody barcode readers or may be peripherally connected to one or more barcode readers.

In various embodiments, client devices 108A-108N may comprise personal devices (e.g., mobile phones, wearable devices, etc.) belonging to one or more users. For example, a user may utilize their personal client device to initiate a generation of a barcode by way of the accounting management system 102, as further discussed herein. Particular components of the remote devices 106A-106N and client devices 108A-108N are described in greater detail below with reference to apparatus 220 in connection with FIG. 2B.

### Example Implementing Apparatuses

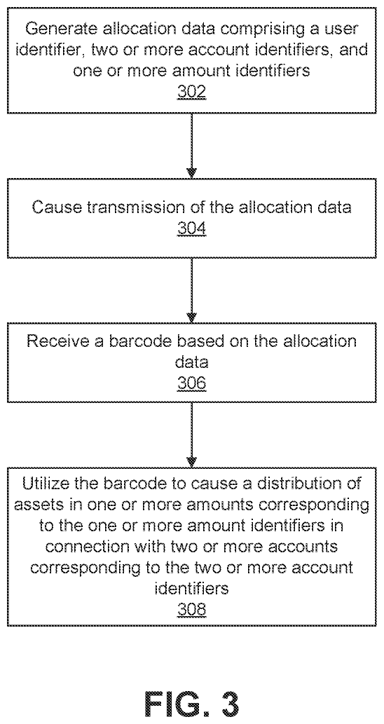

The accounting management system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-7. As illustrated in FIG. 2A, the apparatus 200 may include processor 202, memory 204, communications hardware 206, a barcode generation engine 208, authentication circuitry 210, and a learning engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

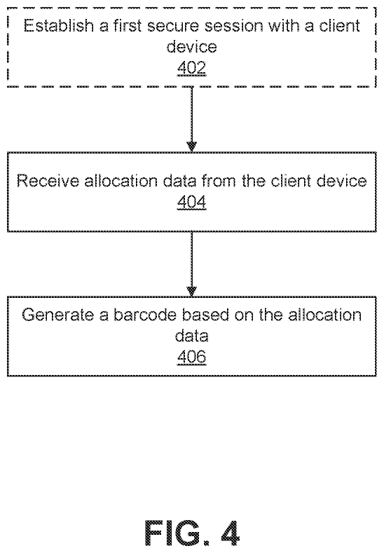

In addition, the apparatus 200 further comprises a barcode generation engine 208 that generates barcodes based on allocation data. The barcode generation engine 208 may utilize processor 202, memory 204, or any other hardware component included in the apparatus 200 to perform these operations, as described in connection with FIG. 4 below. The barcode generation engine 208 may further utilize communications hardware 206 to gather data (e.g., allocation data) from a variety of sources (e.g., client devices 108A-108N, as shown in FIG. 1), and/or exchange data with a user, and in some embodiments may utilize processor 202 and/or memory 204 to generate a barcode based on allocation data.

For example, in some embodiments, the barcode generation engine 208 may generate a barcode by encoding data (e.g., data based on allocation data) into a specific pattern of bars (and/or other shapes) and spaces using a barcode encoding algorithm. The barcode encoding algorithm may convert data (e.g., allocation data) into a binary code, which may then be converted into the specific pattern that can be scanned by a barcode reader. The barcode generation engine 208 may also generate an image of the barcode, which can be displayed, e.g., via a screen of a client device.

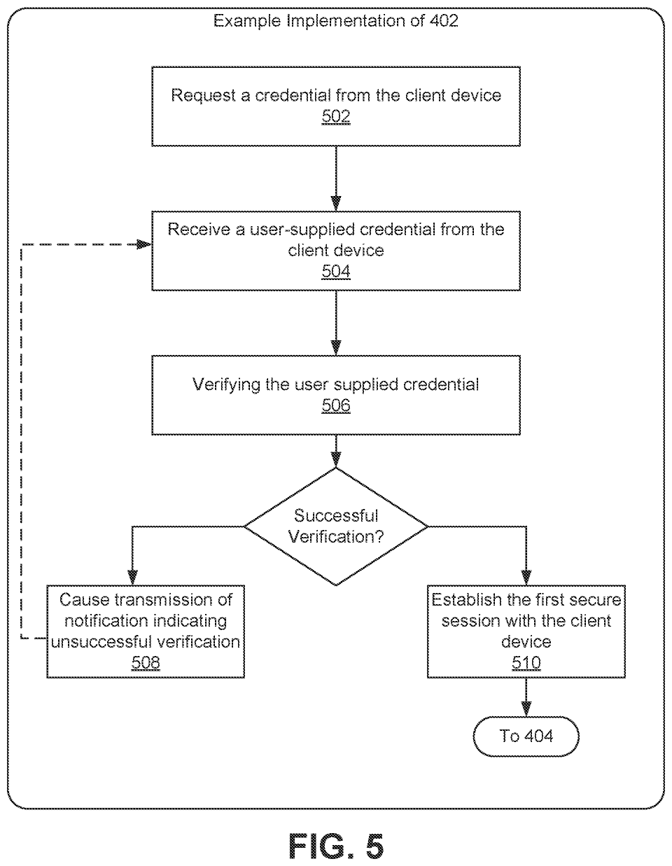

In addition, the apparatus 200 further comprises authentication circuitry 210 that verifies credentials of users and establishes secure communication sessions with devices (e.g., client devices 108A-108N) based on verification of user credentials. The authentication circuitry 210 may utilize processor 202, memory 204, or any other hardware component included in the apparatus 200 to perform these operations, as described in connection with FIG. 5 below. The authentication circuitry 210 may further utilize communications hardware 206 to gather data from a variety of sources (e.g., remote devices 106A-106N and/or client devices 108A-108N, as shown in FIG. 1), and/or exchange data with a user, and in some embodiments may utilize processor 202 and/or memory 204 to verify a user supplied credential and/or establish a secure session with a device.

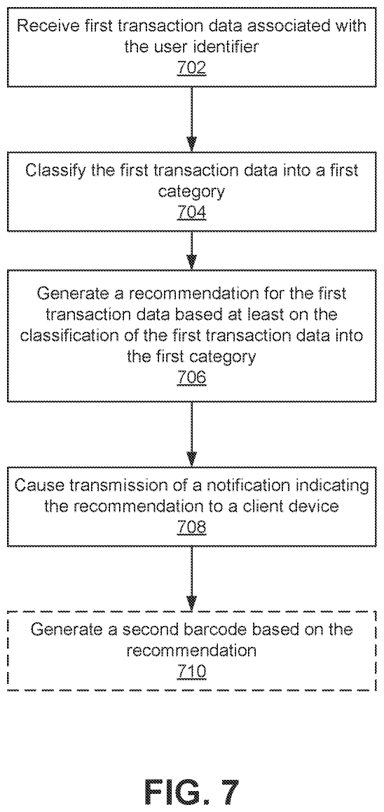

Further, the apparatus 200 further comprises a learning engine 212 that classifies transaction data into categories and generates recommendations for transaction data based on a classification of the transaction data. The learning engine 212 may utilize processor 202, memory 204, or any other hardware component included in the apparatus 200 to perform these operations, as described in connection with FIG. 7 below. The learning engine 212 may further utilize communications hardware 206 to gather data from a variety of sources (e.g., remote devices 106A-106N or client devices 108A-108N, as shown in FIG. 1), and/or exchange data with a user, and in some embodiments may utilize processor 202 and/or memory 204 to classify transaction data into categories and generate recommendations for transaction data based on a classification of the transaction data.

Although components 202-212 are described in part using functional language, it will be understood that the particular implementations necessarily include the use of particular hardware. It should also be understood that certain of these components 202-212 may include similar or common hardware. For example, the barcode generation engine 208, authentication circuitry 210, and learning engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the barcode generation engine 208, authentication circuitry 210, and learning engine 212 may leverage processor 202, memory 204, or communications hardware 206 as described above, it will be understood that any of the barcode generation engine 208, authentication circuitry 210, and learning engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the barcode generation engine 208, authentication circuitry 210, and the learning engine 212 comprise particular machinery designed for performing the functions described herein in connection with such elements of apparatus 200.

As illustrated in FIG. 2B, an apparatus 220 is shown that represents an example remote device (e.g., any of remote devices 106A-106N) or an example client device (e.g., any of client devices 108A-108N). The apparatus 220 includes processor 222, memory 224, and communications hardware 226, and may optionally include authentication circuitry 230, each of which is configured to be similar to the similarly named components described above in connection with FIG. 2A. However, the apparatus 220 also includes data generation circuitry 228, which includes hardware components designed for generating allocation data. The data generation circuitry 228 may utilize processor 222, memory 224, or any other hardware component included in the apparatus 220 to perform these operations, as described in connection with FIG. 3 below. The data generation circuitry 228 may further utilize communications hardware 226 to cause transmission of allocation data (e.g., to the accounting management system 102 by way of communications network 104), or may otherwise utilize processor 222 and/or memory 224 to generate various data, e.g., allocation data.

In some embodiments, various components of the apparatuses 200 and 220 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 220. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-7, example flowcharts are illustrated that contain example operations implemented by example embodiments described herein. The operations illustrated in FIG. 3, may, for example, be performed by a client device (e.g., any of client devices 108A-108N) as shown in FIG. 1, which may in turn be embodied by an apparatus 220, which is shown and described in connection with FIG. 2B. The operations illustrated in FIGS. 4-7 may, for example, be performed by system device of the accounting management system 102 shown in FIG. 1, which may in turn be embodied by an apparatus 200, which is shown and described in connection with FIG. 2A. To perform some of the operations described below, the apparatus 200 may utilize one or more of processor 202, memory 204, communications hardware 206, barcode generation engine 208, authentication circuitry 210, learning engine 212, and/or any combination thereof. Similarly, to perform some of the operations described below, the apparatus 220 may utilize one or more of processor 222, memory 224, communications hardware 226, data generation circuitry 228, authentication circuitry 230 and/or any combination thereof. It will be understood that in some embodiments user interaction with the accounting management system 102 may occur directly via communications hardware 206, or in some embodiments may instead be facilitated by a separate client device 108A-108N or remote device 106A-106N, as shown in FIG. 1, and which, as discussed above, may have similar or equivalent physical componentry facilitating such user interaction.

Turning first to FIG. 3, example operations are shown for utilizing a barcode generated based on allocation data.

In some embodiments, a user may utilize their personal client device (e.g., client device 108A) to initiate a setup of a new barcode they wish to use in the future. The user may interact with a mobile application (e.g., their mobile banking application) installed on their personal device in order to define allocation data, which may then be used to generate a barcode. In this regard, as shown by operation 302, the apparatus 220 includes means, such as processor 222, memory 224, data generation circuitry 228, and/or the like, for generating allocation data. In some embodiments, allocation data may be generated in response to user interaction with one or more interfaces of a mobile application. In other words, allocation data may be generated based on the user specifying, through the interfaces, information as to how they would like a distribution of assets to take place when a barcode is scanned in connection with a transaction. The allocation data may comprise a user identifier, two or more account identifiers, and one or more amount identifiers.

The user identifier may uniquely identify the particular user and may be automatically included in the allocation data based on the user having logged into the mobile application. In some embodiments, the user identifier may comprise an account number, an email address, a username, and/or the like. The two or more account identifiers may each identify a respective account to be associated with the barcode. The account identifiers may identify formal accounts, virtual sub accounts, or a combination of formal accounts and virtual sub accounts. As one example, a user may generate allocation data comprising account identifiers that identify a personal checking account and a personal savings account (i.e., two formal accounts). As another example, a user may generate allocation data comprising account identifiers that identify a first virtual sub account (e.g., a “vacation fund” virtual sub account) of a personal savings account and a second virtual sub account (e.g., a “utility bills” virtual sub account) of the personal savings account (e.g., two virtual sub accounts). As yet another example, a user may generate allocation data comprising account identifiers that identify a personal checking account, a business account, and a virtual sub account (e.g., a “vacation fund” virtual sub account) of a personal savings account (e.g., two formal accounts and one virtual sub account).

The one or more amount identifiers may specify one or more amounts. The one or more amounts may be actual amounts (e.g., in dollars) or percentages (e.g., 5%, 50%, etc.). The amount identifiers may be linked to a respective account identifier. For instance, one or more amount identifiers of the allocation data may indicate that 50% of a financial instrument (e.g., check, cash, or the like) deposited in connection with the barcode be allocated to a personal checking account and the remaining 50% be allocated to a personal savings account. In another example, the one or more amount identifiers of the allocation data may indicate that $20.00 of a financial instrument deposited in connection with the barcode be allocated to a personal checking account and the remaining amount be allocated to a personal savings account. In some embodiments, a user may only provide one amount identifier, and the accounting management system 102 may infer one or more additional amount identifiers based on the provided amount identifier. For example, if the provided amount identifier indicates 50% of a financial instrument deposited in connection with the barcode be allocated to a personal checking account, it may be inferred that the remaining 50% be allocated to a personal savings account, based on the allocation data having account identifier for the personal checking account and an account identifier for the personal savings account.

As shown by operation 304, the apparatus 220 includes means, such as processor 222, memory 224, communications hardware 226, or the like, for causing transmission of the allocation data. For example, the user may confirm various aspects of the generated allocation data and, by selecting a “generate barcode” user interface (UI) element (e.g., a button) or the like, may cause transmission of the allocation data to the accounting management system 102. The accounting management system 102 may then generate a barcode based on the allocation data, as further discussed below in connection with FIG. 4.

As shown by operation 306, the apparatus 220 includes means, such as processor 222, memory 224, communications hardware 226, or the like, for receiving a barcode based on the allocation data. In this regard, the client device may receive the barcode from the accounting management system 102 (e.g., over communications network 104).

Once received, the user may utilize the barcode during a transaction in order to allocate funds at the point of the transaction in real-time via the barcode. In this regard, as shown by operation 308, the apparatus 220 includes means, such as processor 222, memory 224, communications hardware 226, or the like, for utilizing the barcode to cause a distribution of assets in one or more amounts corresponding to the one or more amount identifiers in connection with two or more accounts corresponding to the two or more account identifiers.

In some embodiments, utilizing the barcode may comprise causing display of the barcode at the client device to facilitate a reading of the barcode by a second device. In this regard, the apparatus 220 may include means, such as processor 222, memory 224, communications hardware 226, or the like, for causing display of the barcode at a first device to facilitate a reading of the barcode by a second device. For instance, the barcode may be displayed via a screen of the user's personal client device such that the barcode may be read by a second device, such as a barcode reader or another device (e.g., an ATM or other device) that embodies or is peripherally connected to a barcode reader.

As one example, a user at an ATM who is depositing cash may scan the barcode (e.g., when prompted by the ATM) during a transaction in which the user is depositing the cash. By scanning the barcode, the ATM may acquire the data encoded by the barcode and thus be informed as to how to distribute the cash into one or more accounts (e.g., formal accounts and/or virtual sub accounts) and in what amounts. Similarly, a user may scan the barcode (e.g., displayed on their personal device) at a bank teller station in order to communicate their desired preferences as to how to distribute their cash deposit (as opposed to instructing the bank teller verbally).

In embodiments in which a generated barcode is associated with one or more virtual sub accounts, a user may be enabled to perform a transaction involving scanning of the barcode and, immediately following the transaction, be able to see the change (e.g., a debit or credit) to their virtual sub account(s) reflected in their budgeting software (e.g., by checking their account on their mobile banking application or the like) without having to separately go into their budgeting software and manually adjust the accounts following the transaction.

As noted above, in addition to deposits, barcodes may be generated to facilitate a withdrawal of assets from multiple accounts. For instance, a barcode may be generated based on allocation data indicating a withdrawal of 50% of a designated amount from a personal savings account and 50% of the designated amount from a business account. In this manner, a user may scan the barcode at an ATM, enter the designated amount, and receive cash in the designated amount from their personal savings and business accounts.

In some embodiments, utilizing the barcode may comprise causing transmission of the barcode to a second device to facilitate a reading of the barcode by a third device. In this regard, the apparatus 220 includes means, such as processor 222, memory 224, communications hardware 226, or the like, for causing transmission of the barcode to a second device to facilitate a reading of the barcode by a third device. To illustrate, in some example embodiments, a newly hired employee may provide (e.g., via email) their manager with a barcode that indicates one or more accounts in which they would like their paycheck be directly deposited. The manager, via their device, may scan the barcode with a barcode reader (e.g., at a third device) in order to provide the encoded information to a system that manages direct deposit for employees. In this manner, the employee never has to expose their account information to the manager or potentially others. For example, in many cases, onboarding paperwork for a new employee typically involves the employee writing their account number and routing number on a paper form, which is then scanned, faxed, and/or emailed to additional parties. The original paperwork containing the account information may be left unsecured (e.g., in a back office for some time) and potentially vulnerable to being exposed to other individuals. Advantageously, the employee may avoid this risk by instead providing a barcode encoded with their account information via a more secure means (e.g., an encrypted email message or the like). Further, any potential human error is avoided in situations where the employee may write down or otherwise provide the wrong account information in error, resulting in delayed processing and potentially a delay in receiving their paycheck.

Turning to FIG. 4, generating a barcode based on allocation data. As noted above, the operations shown in FIGS. 4-7 may be performed by system device of the accounting management system 102 shown in FIG. 1, which may in turn be embodied by an apparatus 200, which is shown and described in connection with FIG. 2A.

In some embodiments, a secure session between the accounting management system 102 (e.g., a system device) and a client device may be established before any generation and/or transmission of allocation data (e.g., at the client device) and/or generation and/or transmission of barcodes (e.g., by the accounting management system 102) takes place. A secure session may be established between the two devices in order to ensure confidentiality, integrity, and authenticity of the data being transmitted (e.g., allocation data and/or barcodes). In some embodiments, a secure session may use encryption to protect data and prevent unauthorized access, modification, or interception by attackers. In this regard, as shown in optional operation 402, the apparatus 200 includes means, such as processor 202, memory 204, authentication circuitry 210, or the like, for establishing a first secure session with a client device.

Turning briefly to FIG. 5, example operations are shown which may be performed in order to establish a secure session.

In some embodiments, a user of the client device may first be authenticated via a credential, to ensure that data is only transmitted between authorized parties. As shown by operation 502, the apparatus 200 includes means, such as processor 202, memory 204, communications hardware 206, or the like, for requesting a credential from the client device. In some embodiments, the request may be automatically sent during a login attempt to a mobile banking application by the user.

In some embodiments, e.g., during registration with a mobile banking application or other application associated with the accounting management system 102, an individual may create a credential associated with their user identifier. For example, in some embodiments, a credential may comprise a Personal Identification Number (PIN), password, secret question and answer, and/or other similar alphanumeric-based credential. In some embodiments, a credential may comprise a biometric marker of the individual. For example, the individual may provide a fingerprint (or other biometric) via the mobile application during registration such that the submitted credential is stored in association with their user identifier by the accounting management system 102. In this regard, the apparatus 200 includes means, such as processor 202, memory 204, communications hardware 206, or the like, for storing a user identifier in association with a credential. In some embodiments, the stored credential may be verified each time the individual engages with the accounting management system 102 (e.g., via a mobile application) and/or each time a secure session with the accounting management system 102 needs to be established.

In response to the request, a user may supply the requested credential. As shown by operation 504, the apparatus 200 includes means, such as processor 202, memory 204, communications hardware 206, or the like, for receiving a user-supplied credential from the client device. For example, in examples in which the credential is a biometric marker such as a fingerprint, the individual may supply their fingerprint via a fingerprint scanner of their personal client device. In this regard, the apparatus 220 (e.g., the client device) includes means, such as processor 222, memory 224, communications hardware 226, authentication circuitry 230, or the like, for facilitating transmission of a user-supplied credential.

The accounting management system 102 may then verify the credential upon receiving the credential. In this regard, as shown in operation 506, the apparatus 200 includes means, such as processor 202, memory 204, authentication circuitry 210, or the like, for verifying the user-supplied credential. In some embodiments, the verification may involve comparing the user-supplied credential with a stored credential associated with the user identifier. For example, the accounting management system 102 may verify that the credential submitted in response to the credential request matches a stored credential associated with the user identifier (e.g., the stored credential being the credential initially supplied by the user during registration or the like).

In some embodiments, such as instances in which the credential is a biometric marker (e.g., a fingerprint), the accounting management system 102 may confirm that the submitted credential shares enough similarities to a stored biometric marker to satisfy a predefined similarity threshold. For example, the authentication circuitry 210 may preprocess the submitted biometric marker (e.g., to remove noise, inconsistencies, or the like) and compare the preprocessed biometric marker to the stored biometric marker using a matching algorithm, such as minutiae-based matching or pattern matching. A resulting match score may then be compared with a predefined similarity threshold. In some embodiments, if the match score exceeds the predefined similarity threshold, the credential may be successfully verified.

As shown in FIG. 5, if the credential cannot be successfully verified, the method may continue to operation 508, wherein the apparatus 200 includes means, such as processor 202, memory 204, communications hardware 206, or the like, for causing transmission of a notification indicating an unsuccessful verification of the credential. The notification may be transmitted back to the client device for presentation at the client device. In this regard, the notification may prompt (e.g., via a display of the notification) the user to resubmit their credential (e.g., due to a potential bad reading of a biometric or mistyping of a PIN). As shown in FIG. 5, the method may then return to operation 504, wherein the accounting management system 102 may receive another user-supplied credential in an attempt to verify the user-supplied credential.

In response to a successful verification of the credential, the method may continue to operation 510, wherein the apparatus 200 includes means, such as processor 202, memory 204, authentication circuitry 210, or the like, for establishing the first secure session with the client device. In this regard, in some embodiments, a secure session may be established in response to a successful verification of the user-supplied credential.

Returning to FIG. 4, once a secure session between a client device and the accounting management system 102 is (optionally) established, allocation data may then be received, e.g., from the client device. As shown by operation 404, the apparatus 200 includes means, such as processor 202, memory 204, communications hardware 206, or the like, for receiving allocation data from the client device. As discussed above in connection with operations 302 and 304 of FIG. 3, the client device may generate allocation data and cause transmission of the allocation data to the accounting management system 102.

As shown by operation 406, the apparatus 200 includes means, such as processor 202, memory 204, barcode generation engine 208, or the like for generating a barcode based on the allocation data.

In some embodiments, the barcode may comprise a QR code. In some embodiments, QR codes may be used due to their ability to store more data than some traditional types of barcodes as well as their ability to be read by more devices (e.g., smartphones). To generate the barcode (e.g., a QR code), the barcode generation engine 208 may convert the allocation data into a 2D pattern of squares (e.g., black and white squares). The barcode generation engine 208 may then encode the 2D pattern into a QR code format using an algorithm (e.g., the Reed-Solomon algorithm). The barcode, once generated, may then be scanned (e.g., via a barcode reader, smartphone, etc.) in order to access the stored data. In other words, when scanned, the data encoded into the barcode may instruct a device (e.g., a system device of the accounting management system 102 or other device) on how to allocate certain digital assets (e.g., funds) between multiple formal accounts and/or multiple virtual sub accounts.

In some embodiments, once the barcode is generated, the accounting management system 102 may store the barcode in association with the user identifier. In this regard, the apparatus 200 includes means, such as processor 202, memory 204, communications hardware 206, or the like, for storing the barcode in association with the user identifier. In this manner, the user, e.g., when logged into their mobile banking application (with their user identifier), is able to view the generated barcode and browse other barcodes that have been generated through the accounting management system 102 in association with their user identifier.

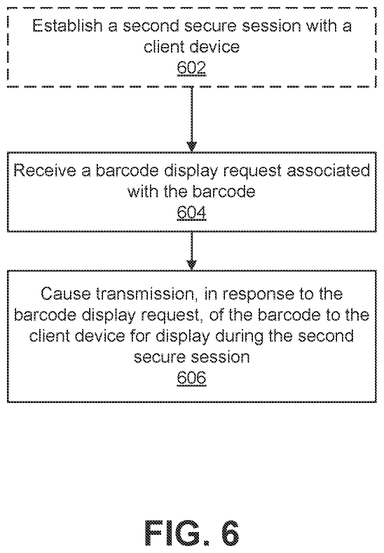

Turning to FIG. 6, example operations are shown for facilitating a display of a barcode in connection with a barcode display request.

As shown by optional operation 602, the apparatus 200 includes means, such as processor 202, memory 204, authentication circuitry 210, or the like, for establishing a second secure session with a client device. For example, the second secure session may be established in the event a user logs into their mobile banking application at a later time to access one or more barcodes. The second secure session may be established in a manner similar to the first secure session discussed above in connection with operation 402 of FIG. 4 and operations 502-510 of FIG. 5. Establishing a secure session, e.g., by verifying a biometric or similar credential of a user, with a client device prior to causing transmission or presentation of barcode(s) at a client device may provide increased security and help prevent barcode(s) from being compromised or otherwise tampered with if a bad actor were to gain access to the client device.

As shown by operation 604, the apparatus 200 includes means, such as processor 202, memory 204, communications hardware 206, or the like, for receiving a barcode display request associated with the barcode. In this regard, a user, at their client device, may browse identifiers previously generated barcodes associated with their user identifier (e.g., based on a listing of the barcodes according to given identifiers (e.g., titles or names) or the like) and select an identifier in order to display the barcode at their device. In some embodiments, upon selection, a barcode display request (e.g., comprising the selected identifier) may be automatically generated and transmitted to the accounting management system 102. In this regard, the apparatus 220 includes means, such as processor 222, memory 224, communications hardware 226 or the like, for generating a barcode display request. The apparatus 220 also includes means, such as processor 222, memory 224, communications hardware 226, or the like, for causing transmission of a barcode display request. The accounting management system 102 may then identify the selected barcode based on the identifier and cause transmission of the barcode to the client device for display. As shown in operation 606, the apparatus 200 includes means, such as processor 202, memory 204, communications hardware 206, or the like, for causing transmission in response to the barcode display request, of the barcode to the client device for display during the second secure session.

In some example embodiments, once a barcode (or multiple barcodes) have been defined and generated by a user as described above, the user may begin utilizing the barcode in connection with transactions (e.g., withdrawals, deposits, purchases, etc.). For instance, if a user visits a bank branch or ATM and transacts a check deposit, the user may scan their barcode in connection with the transaction (e.g., via a barcode reader at the ATM or bank teller station, or their client device (e.g., when performing a mobile check deposit) or the like). By doing so, the accounting management system 102 may receive transaction data comprising the barcode identifier of the barcode scanned as well as additional information regarding the transaction. In this regard, the apparatus 200 includes means, such as processor 202, memory 204, communications hardware 206, or the like, for receiving transaction data comprising a barcode identifier. In the example of a check deposit, the transaction data may comprise details about the check deposit (e.g., the amount of the check and other details of the check, date and/or time of the deposit, etc.). In this regard, the accounting management system 102 may be enabled to provide near-instantaneous updates to one or more accounts associated with the scanned barcode. In this regard, the apparatus 200 includes means, such as processor 202, memory 204, learning engine 212, or the like, for modifying one or more accounts based on the transaction data. For example, if the scanned barcode designates two or more virtual sub accounts to allocate money into from the check deposit, these virtual sub accounts may be updated to reflect the new amounts in or in near real time, such that the user, upon checking their bank account via their mobile banking application, may view the amounts already reflected in the virtual sub accounts, without having to manually adjust the accounts themselves based on the deposited check.

Similarly, in the example of a withdrawal, the transaction data may comprise details about the withdrawal (e.g., an amount of funds requested, date and/or time of the withdrawal, etc.), such that the accounting management system 102 may perform near-instantaneous updates to one or more accounts associated with the barcode which was scanned in connection with the withdrawal.

As another example, a user may conduct a transaction involving a purchase of a good or service. For example, the user may scan their barcode in connection with the transaction (e.g., via a barcode reader at merchant POS device station, or their client device (e.g., when making an online purchase) or the like). In this regard, the transaction data received by the accounting management system 102 may comprise details about the purchase (e.g., the purchase amount, date and/or time of the purchase, types of goods or services purchased, etc.), such that the accounting management system 102 may perform near-instantaneous updates to one or more accounts associated with the barcode which was scanned in connection with the purchase.

In some examples, transaction data may be received by the accounting management system 102 that does not comprise a barcode identifier. For example, the user may make a purchase (e.g., at a merchant) with a debit card linked to their personal checking account without scanning a barcode. As the personal checking account may have multiple associated virtual sub accounts, it may be unclear as to which virtual sub account balances should be deducted based on the purchase. Advantageously, in some embodiments, the accounting management system 102 (e.g., via a learning engine 212) may process the transaction data to determine a recommendation for a distribution of assets in connection with the transaction data.

Turning to FIG. 7, example operations are shown for generating a recommendation based on received transaction data.

Continuing with the example above, transaction data may be received by the accounting management system 102 that does not comprise a barcode identifier, for example, in an instance in which a user makes a purchase (e.g., at a merchant) with a debit card linked to their personal checking account without scanning a barcode. As shown by operation 702, the apparatus 200 includes means, such as processor 202, memory 204, communications hardware 206, or the like, for receiving first transaction data associated with the user identifier. In some embodiments, as discussed above, the user identifier may be any unique identifier associated with the user, such as an account number, email address, username, or other identifying information. The transaction data may be received by the accounting management system 102 from a variety of sources, e.g., POS device(s), an online shopping cart, a mobile payment application, or the like. As discussed above, transaction data may comprise details about the transaction, such as, for example, a purchase amount, a merchant identifier (e.g., data indicating a specific merchant, such as a retailer, restaurant, or other type of merchant), an identifier indicating a type of goods or services purchased, a date and/or time of the purchase, and the like.

As shown by operation 704, the apparatus 200 includes means, such as processor 202, memory 204, learning engine 212, or the like, for the first transaction data into a first category. For example, in some embodiments, learning engine 212 may extract features from the truncation data and compare the extracted features to a set of predefined rules to determine a category to which the transaction belongs. Categories may be predefined categories relating to certain purchases and may include, for example, food expense, clothing expense, utility expense, rent/mortgage expense, etc. In some embodiments, learning engine 212 may utilize a machine learning (ML) model, artificial intelligence (AI) model and/or the like to classify transaction data. For example, learning engine 212 may extract relevant features from the transaction data and feed the extracted features into a ML model. The ML model may be trained using, e.g., a large dataset of labeled transactions to recognize patterns and allocate transaction data into a predefined category. In some embodiments, the ML model may be trained based on historical transaction data of the user. In this regard, in some embodiments, the ML model may recognize an appropriate category for a specific purchase based on the purchase having been previously made (e.g., in which a barcode was scanned in connection with the previous purchase).

As shown by operation 706, the apparatus 200 includes means, such as processor 202, memory 204, learning engine 212, or the like, for generating a recommendation for the first transaction data based at least on the classification of the first transaction data into the first category. In some embodiments, the recommendation comprises one or more recommended accounts to associate with a distribution of assets in connection with the transaction data. For example, continuing with the example above, learning engine 212 may identify one or more virtual sub accounts of the user's personal checking account based on the classification of the transaction data into a predefined category. For instance, if a purchase of food from a grocery store was categorized as a food expense, the learning engine 212 may identify a “groceries” virtual sub account (e.g., a “groceries” bucket) associated with the personal checking account and generate a recommendation that the funds be deducted from the groceries virtual sub account to accurately reflect the transaction in the context of the user's budget or monthly expenses.

As shown by operation 708, the apparatus 200 includes means, such as processor 202, memory 204, communications hardware 206, or the like for causing transmission of a notification indicating the recommendation to a client device. For instance, continuing with the above example, immediately following a purchase of food (e.g., without scanning a barcode), the user may be prompted at their client device with a recommendation for attributing the purchase of food to their groceries virtual sub account. In some embodiments, the user may respond to the recommendation by affirming or denying the recommendation. In this regard, the apparatus 220 includes means, such as processor 222, memory 224, communications hardware 226 for receiving a notification comprising a recommendation. The apparatus 220 also includes means, such as processor 222, memory 224, communications hardware 226, or the like, for causing transmission of a response to the notification. If the response comprises an affirmative response to the recommendation, the accounting management system 102 may proceed with modifying one or more accounts based on the transaction data, e.g., reducing the balance of the groceries virtual sub account based on the food purchase. In this regard, the apparatus 200 includes means, such as processor 202, memory 204, communications hardware 206, or the like, for receiving a response to the notification.

In some embodiments, if the response comprises an affirmative response to the recommendation, the accounting management system 102 may optionally generate a barcode for the user based on the recommendation. As shown by operation 710, the apparatus 200 includes means, such as processor 202, memory 204, barcode generation engine 208, or the like, for generating a second barcode based on the recommendation. For instance, continuing with the above example, a new barcode may be generated that, when scanned in connection with a transaction, attributes the transaction to the groceries virtual sub account of the user's personal checking account. In this manner, going forward, the user may scan the newly generated barcode when making a purchase that they wish to be reflected in their groceries virtual sub account.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved management of multiple accounts through barcode-based digital asset allocation. Example embodiments thus provide tools that overcome the problems faced by individuals who utilize existing budgeting software and virtual sub accounts. By providing a barcode-based solution to instantaneously update one or more accounts (e.g., formal accounts and/or virtual sub accounts) in connection with a transaction, embodiments described herein avoid the need to manually evaluate transactions and allocate assets based on said transactions, example embodiments thus save time and resources, while also eliminating the possibility of human error that has been unavoidable in the past. Moreover, embodiments described herein increase privacy by allowing an allocation of funds to be automatically distributed in connection with multiple accounts via scanning of a barcode. In this regard, unsecure conventional approaches, such as speaking desired allocations of funds out loud to a bank teller (which may be eavesdropped on by third parties), are avoided. Finally, by automating functionality that has historically required separate human analysis, the speed and consistency of the operations performed by example embodiments unlocks many potential new functions that have historically not been available, such as the ability to conduct near-real-time digital asset allocation.

As these examples all illustrate, example embodiments contemplated herein provide technical solutions that solve real-world technical problems faced by existing budgeting software implementations as well as financial transacting more generally. The recently arising ubiquity of barcodes such as QR codes has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
generating, by data generation circuitry, allocation data comprising a user identifier, two or more account identifiers, and one or more amount identifiers;
causing transmission, by communications hardware, of the allocation data;
receiving, by the communications hardware, a barcode based on the allocation data; and
utilizing, by the communications hardware, the barcode to cause a distribution of assets in one or more amounts corresponding to the one or more amount identifiers in connection with two or more accounts corresponding to the two or more account identifiers.

2. The method of claim 1, wherein utilizing the barcode comprises:
causing display, by the communications hardware, of the barcode at a first device to facilitate a reading of the barcode by a second device.

3. The method of claim 1, wherein utilizing the barcode comprises:
causing transmission, by the communications hardware, of the barcode to a second device to facilitate a reading of the barcode by a third device.

4. The method of claim 1, wherein the distribution comprises an allocation of the assets in the one or more amounts to the two or more accounts.

5. The method of claim 1, wherein the distribution comprises a withdrawal of the assets from the two or more accounts in the one or more amounts.

6. The method of claim 1, wherein the two or more accounts comprise two or more virtual sub accounts associated with one or more formal accounts.

7. The method of claim 1, wherein the two or more accounts comprise two or more formal accounts.

8. An apparatus comprising:
data generation circuitry configured to generate allocation data comprising a user identifier, two or more account identifiers, and one or more amount identifiers; and
communications hardware configured to:
cause transmission of the allocation data,
receive a barcode based on the allocation data, and
utilize the barcode to cause a distribution of assets in one or more amounts corresponding to the one or more amount identifiers in connection with two or more accounts corresponding to the two or more account identifiers.

9. The apparatus of claim 8, wherein the communications hardware is configured to utilize the barcode by causing display of the barcode at a first device to facilitate a reading of the barcode by a second device.

10. The apparatus of claim 8, wherein the communications hardware is configured to utilize the barcode by causing transmission, by the communications hardware, of the barcode to a second device to facilitate a reading of the barcode by a third device.

11. The apparatus of claim 8, wherein the distribution comprises an allocation of the assets in the one or more amounts to the two or more accounts.

12. The apparatus of claim 8, wherein the distribution comprises a withdrawal of the assets from the two or more accounts in the one or more amounts.

13. The apparatus of claim 8, wherein the two or more accounts comprise two or more virtual sub accounts associated with one or more formal accounts.

14. The apparatus of claim 8, wherein the two or more accounts comprise two or more formal accounts.

15. A computer program product comprising at least one non-transitory computer-readable storage medium storing software instructions that, when executed, cause an apparatus to:
generate allocation data comprising a user identifier, two or more account identifiers, and one or more amount identifiers;
cause transmission of the allocation data;
receive a barcode based on the allocation data; and
utilize the barcode to cause a distribution of assets in one or more amounts corresponding to the one or more amount identifiers in connection with two or more accounts corresponding to the two or more account identifiers.

16. The computer program product of claim 15, wherein the software instructions, when executed, cause the apparatus to utilize the barcode by:
causing display of the barcode at a first device to facilitate a reading of the barcode by a second device.

17. The computer program product of claim 15, wherein the software instructions, when executed, cause the apparatus to utilize the barcode by:
causing transmission of the barcode to a second device to facilitate a reading of the barcode by a third device.

18. The computer program product of claim 15, wherein the distribution comprises at least one of (i) an allocation of the assets in the one or more amounts to the two or more accounts and (ii) a withdrawal of the assets from the two or more accounts in the one or more amounts.

19. The computer program product of claim 15, wherein the two or more accounts comprise two or more virtual sub accounts associated with one or more formal accounts.

20. The computer program product of claim 15, wherein the two or more accounts comprise two or more formal accounts.

21-40. (canceled)
